(19) United States
(12) Patent Application Publication
(10) Pub. No.: US 2008/0237461 A1
(43) Pub. Date: Oct. 2, 2008

(54) Autofocus method in a scanning electron microscope

(75) Inventors: Jong-Deok Kim, Gyeonggi-do (KR); Byung-Am Lee, Gyeonggi-do (KR); Kyung-Ho Kim, Gyeonggi-do (KR); Byung-Seol Ahn, Gyeonggi-do (KR); Young-Hun Park, Gyeonggi-do (KR); Kong-Jung Sa, Daegu (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/079,166

(22) Filed: Mar. 25, 2008

(30) Foreign Application Priority Data
Mar. 26, 2007 (KR) 10-2007-0029168

(51) Int. Cl. G21K 7/00

(52) U.S. Cl. 250/307

(57) ABSTRACT

In an autofocus method, an electron beam is scanned onto a subject through a condensing member. A setting condition of the condensing member is changed within a first range. An image evaluation value is measured using a secondary electron current from the subject according to the setting condition within the first range. A second range adjacent to the first range and including the setting condition corresponding to the first maximum is set when a first maximum of the image evaluation value is not a peak value. The setting condition is changed within the second range. An image evaluation value is measured using a secondary electron current according to the setting condition within the second range. The condensing member is set with the setting condition corresponding to a second maximum of the image evaluation value when the second maximum value is the peak value.

### CROSS-REFERENCE TO RELATED APPLICATIONS

This application claims priority under 35 U.S.C. §119 to Korean Patent Application No. 10-2007-0029168, filed on Mar. 26, 2007 in the Korean Intellectual Property Office (KIPO), the contents of which are herein incorporated by reference in their entirety.

### BACKGROUND OF THE INVENTION

1. Field of the Invention

Example embodiments of the present invention relate to an autofocus method in a scanning electron microscope (SEM). More particularly, example embodiments of the present invention relate to an autofocus method in a SEM in which optimum images of patterns on a substrate may be obtained.

2. Description of the Related Art

Generally, semiconductor devices are manufactured by forming layers on a substrate and patterning the layers. After forming patterns on the substrate, an inspection process for inspecting whether the patterns have desired shapes and widths is performed.

A scanning electron microscope (SEM) is usually used for inspecting patterns on a substrate and detecting defects of the patterns. In a method for inspecting the patterns on the substrate, electron beams are scanned on the patterns on the substrate, signals of secondary electrons from the patterns are converted into image signals, and the patterns may be inspected using the image signals. Additionally, defects of the patterns or undesired particles on the patterns may be detected using the image signals.

The SEM includes an electron gun for generating an electron beam. The electron beam generated by the electron gun sequentially passes through a condenser lens, a deflecting coil, an object lens and an iris, and is focused. The focused electron beam is scanned onto the substrate. Secondary electrons emitted from the substrate are detected by a detector and signals are generated. The signals are amplified by an amplifier and scanned onto a fluorescent surface on the inside of a cathode ray tube (CRT), so that images of the patterns on the substrate may be formed.

In order to inspect the patterns, measure the widths of the patterns, or detect the defects of the patterns, clear images of the patterns must be obtained. When the images of the patterns are not clear, the measured widths of the patterns may be different from actual widths of the patterns, or detecting the defects may be difficult.

Additionally, clear images of the patterns may be obtained using the SEM only when focusing between the patterns and the electrons scanned onto the patterns is good,. Thus, obtaining an optimum focal point between the patterns and the electrons scanned onto the patterns is important.

An autofocus method in a SEM is disclosed in Japanese Patent Laid-Open Publication Nos. 2001-110347 and 2000-277046.

In the autofocus method disclosed in Japanese Patent Laid-Open Publication No. 2001-110347, vertical, horizontal and circular scanning signals are scanned onto a specific portion of a sample in stages, and absolute values and voltages of secondary electrons emitted from the sample by the scanning signals are obtained. A first autofocus process is performed using a maximum value in an intensity distribution of the absolute value of the secondary electrons. After setting a voltage range using the value set by the first autofocus process, a second autofocus process for setting an optimum voltage value is performed by the circular scanning signal. In the above method, since both the first autofocus process for setting the voltage range and the more precise second autofocus process are performed, a large amount of time is needed to perform the autofocus method. Additionally, when the time for focusing becomes longer, excess electrons may be scanned onto the sample, thereby causing damage to the sample.

In the autofocus method disclosed in Japanese Patent Laid-Open Publication No. 2000-277046, voltages of an object lens are changed to detect a maximum value in an x-direction and a maximum value in a y-direction. A focal point is obtained based on the maximum values in the x- and y-directions. However, an optimum focal point may not be obtained even by this method.

### SUMMARY OF THE INVENTION

Example embodiments of the present invention provide an autofocus method in which a focus may be accurately controlled in a scanning electron microscope (SEM).

According to one aspect, the present invention is directed to an autofocus method. According to the autofocus method, an electron beam is scanned onto a subject through a condensing member. A setting condition of the condensing member is changed within a first range in stages. An image evaluation value is measured using a first secondary electron current from the subject according to the setting condition within the first range. A second range is set when a first maximum value of the image evaluation value is not a peak value. The second range is adjacent to the first range and includes the setting condition corresponding to the first maximum value. The setting condition is changed within the second range in stages. An image evaluation value is measured using a second secondary electron current from the subject according to the setting condition within the second range. The condensing member is set with the setting condition corresponding to a second maximum value of the image evaluation value when the second maximum value is the peak value.

In an example embodiment of the present invention, the condensing member may include an object lens and/or a coil.

In an example embodiment of the present invention, the setting condition may be a voltage applied to the object lens when the condensing member includes the object lens. In an example embodiment of the present invention, the setting condition may be a resistance of the coil when the condensing member includes the coil.

In an example embodiment of the present invention, an image of the subject may be obtained by scanning an electron beam onto the subject through the condensing member that has been set by the setting condition corresponding to the peak value of the image evaluation value. Patterns on the subject may be inspected using the obtained image.

In an example embodiment of the present invention, when the second maximum value is not the peak value, the following steps may be further performed: i) setting an n-th range, which is adjacent to an (n−1)th range and includes the setting condition corresponding to an (n−1)th maximum value of the image evaluation value within the (n−1)th range (n is an integer over 3); ii) changing the setting condition within the n-th range in stages; iii) measuring an image evaluation value using an n-th secondary electron current from the subject according to the setting condition within the n-th range; iv) checking whether an n-th maximum value of the image evaluation value within the n-th range is the peak value; and v) repeatedly performing steps i) to iv), when the n-th maximum value is not the peak value.

In an example embodiment of the present invention, the second range may be set to include a setting condition at which the image evaluation value is higher than that of the first range.

According to another aspect, the present invention is directed to an autofocus method. In the autofocus method, an electron beam is scanned onto a subject through an object lens. A first plurality of voltages within a first voltage range is applied to the object lens in stages. An image evaluation value is measured using a first secondary electron current from the subject according to the voltage applied to the object lens within the first range. A second voltage range is set when a first maximum value of the image evaluation value within the first voltage range is not a peak value. The second voltage range is adjacent to the first voltage range and includes the voltage corresponding to the first maximum value. A second plurality of voltages within the second voltage range is applied to the object lens in stages. An image evaluation value is measured using a second secondary electron current from the subject according to the voltage applied to the object lens within the second voltage range. A voltage applied to the object lens is obtained when a second maximum value of the image evaluation value within the second voltage range is the peak value. The obtained voltage corresponding to the peak value is applied to the object lens.

In an example embodiment of the present invention, a portion of the second voltage range that does not belong to the first voltage range may be in a range of about 30% to about 90% based on the total second voltage range.

In an example embodiment of the present invention, the second voltage range may be set to include a voltage at which the image evaluation value is higher than that of the first voltage range.

In an example embodiment of the present invention, when the second maximum value is not the peak value, the following steps may be further performed: i) setting an n-th voltage range, which is adjacent to an (n−1)th range and includes the voltage corresponding to an (n−1)th maximum value of the image evaluation value within the (n−1)th voltage range (n is an integer over 3); ii) applying a plurality of voltages to the object lens within the n-th range in stages; iii) measuring an image evaluation value using an n-th secondary electron current from the subject according to the voltage within the n-th range; iv) checking whether an n-th maximum value of the image evaluation value within the n-th voltage range is the peak value; and v) repeatedly performing steps i) to iv), when the n-th maximum value is not the peak value.

In an example embodiment of the present invention, an image of the subject may be obtained by scanning an electron beam onto the subject through the object lens that has been set by the voltage corresponding to the peak value. Patterns on the subject may be inspected using the obtained image.

According to some example embodiments of the present invention, an optimum focal point may be obtained by applying an object lens voltage corresponding to a peak value of an image evaluation value. Particularly, whether a maximum value of the image evaluation value within a specific range is the peak is checked, and if the maximum value is not the peak value, another range is set. Thus, after obtaining the peak value, the optimum focal point may be obtained by applying the voltage corresponding to the peak value to the object lens. Thus, clear images of a subject may be obtained using a SEM, and defects of the subject or the size of patterns formed on the subject may be accurately detected without causing damage to the subject due to excessive exposure to an electron beam.

### BRIEF DESCRIPTION OF THE DRAWINGS

The foregoing and other objects, features and advantages of the invention will be apparent from the more particular description of preferred aspects of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating a scanning electron microscope (SEM) in accordance with some example embodiments of the present invention.

FIG. 2 is a flowchart illustrating an autofocus method in the SEM in FIG. 1 in accordance with some example embodiments of the present invention.

FIG. 3 is a SEM image of the patterns on the substrate before controlling the focus.

FIG. 4 is a graph showing the image evaluation value measured in stages within the first voltage range.

FIG. 5 is a SEM image of the patterns on the substrate when the highest value within the first voltage range was applied to the object lens.

FIG. 6 is a graph showing the image evaluation value measured in stages within the second voltage range.

FIG. 7 is a SEM image of the patterns on the substrate when the highest value within the second voltage range was applied to the object lens.

FIG. 8 is a graph showing the image evaluation value measured in stages within the third voltage range.

FIG. 9 is a SEM image of the patterns on the substrate when the 12^{th} value within the third voltage range was applied to the object lens.

FIG. 10 is a flowchart illustrating an autofocus method in the SEM in FIG. 1 in accordance with other example embodiments of the present invention.

### DETAILED DESCRIPTION OF PREFERRED EMBODIMENTS

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

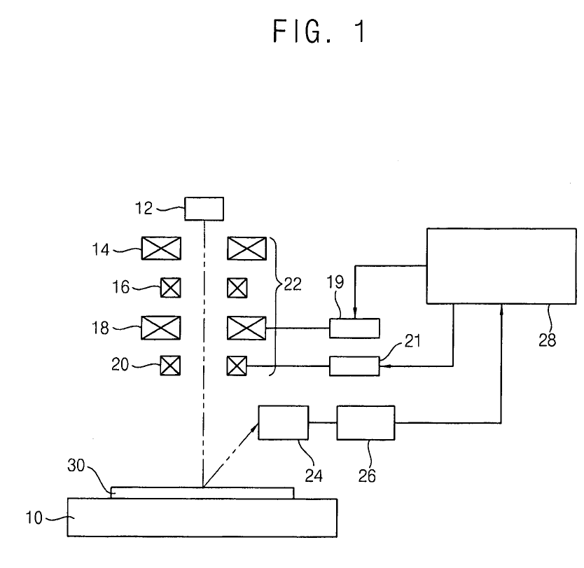

FIG. 1 is a block diagram illustrating a scanning electron microscope (SEM) in accordance with some example embodiments of the present invention.

Referring to FIG. 1, the SEM includes a vacuum chamber (not shown), a stage 10 for supporting a subject 30 in the chamber, a measurement unit disposed over the stage 10, which obtains an image of secondary electrons emitted from the subject 30 and enlarges the image, and an autofocus unit 28 for automatically controlling a focus between the subject 30 and an electron beam for inspection.

The measurement unit and the autofocus unit 28 are disposed in the vacuum chamber, because focusing by a lens or detecting electrons in the atmosphere is difficult due to the tendency of electrons to collide with particles and be scattered.

The stage 10 on which the subject 30 is mounted is disposed in the vacuum chamber.

The measurement unit includes a lens assembly 22 and an electron gun 12 for generating an accelerated electron beam. The lens assembly 22 includes a condenser lens 14, a deflecting coil 16, an object lens 18 and an auxiliary coil 20. A detector 24 detects the secondary electrons emitted from the subject 30 due to a surface reaction with the accelerated electrons. An analog-to-digital converter (ADC) 26 converts a signal from the detector 24 to a digital signal and transfers the digital signal to the autofocus unit 28.

Each of the lenses 16 and 18 included in the lens assembly 22 may be a magnetic lens including coils of copper wires inside iron pole pieces. A current through the coils creates a magnetic field in a bore of the pole pieces. The rotationally symmetric magnetic field is inhomogeneous in such a way that the magnetic field is weak in the center of the gap and becomes stronger close to the bore. Electrons close to the center are less strongly deflected than those passing through the lens far from the optical axis. Thus, a beam of parallel electrons is focused into a spot because electrons passing along the optical axis are accelerated by the magnetic field and rotated about the optical axis in a corkscrew fashion. The magnetic lens may act as a convex lens.

The condenser lens 14 may concentrate the accelerated electron beam from the electron gun 12 into a small area, and may be used to set the intensity of the electron beam.

The object lens 18, which may be referred to as an electron beam formation lens, may adjust the size of the electron beam scanned onto the sample. For example, when a focal distance is small and the object lens 18 is positioned close to the subject 30, an electron beam having a small size may be formed. As the object lens 18 is positioned closer to the subject 30, a smaller point is formed so that a resolving power may be increased. The object lens 18 includes a scanning coil, an iris or an astigmatic coil therein. Even though the magnification of an image is changed, a focus is not changed because the electron beam is focused on a surface of the subject 30 by the object lens 18.

A first power supply 19 is connected to the object lens 18, thereby applying a power source to the object lens 18. The focus between the subject 30 and the electron beam may be changed according to a voltage or a current of the object lens 18. That is, the size of the electron beam scanned onto the sample may be controlled by changing the voltage or the current applied to the object lens 18.

The auxiliary coil 20 may be disposed under the object lens 18 and may control the size of the electron beam. A second power supply 21 is connected to the auxiliary coil 20.

The detector 24 may detect the secondary electrons from the subject 30 and generate a detection signal. The detection signal may be amplified by an amplifier (not shown). The amplified signal may be converted into a digital signal by the ADC 26, and the digital signal may be converted into a gray-level image. The detection signal may be changed according to an amount of the secondary electrons detected by the detector 24, and the detection signal may be measured as an image evaluation value after passing through the ADC 26. As the amount of the secondary electrons from the subject 30 increases, the image evaluation value also increases and the focus quality between the subject 30 and the electron beam may become better.

The autofocus unit 28 automatically controls the focus between the subject 30 and the lens assembly 22, and includes a recipe setting member that sets steps for controlling the focus.

The recipe member includes a condition input part, a memory part and a focus search part. The condition input part may change setting conditions for a condensing member such as the object lens 18 or the auxiliary coil 20. The memory part may store a current of the secondary electrons, which is measured at each of the setting conditions, and an image evaluation value generated by the secondary electron current. The focus research part may search for an optimum focus from the image evaluation value.

Hereinafter, a method for searching for an optimum focal point within a short time using the above SEM is described.

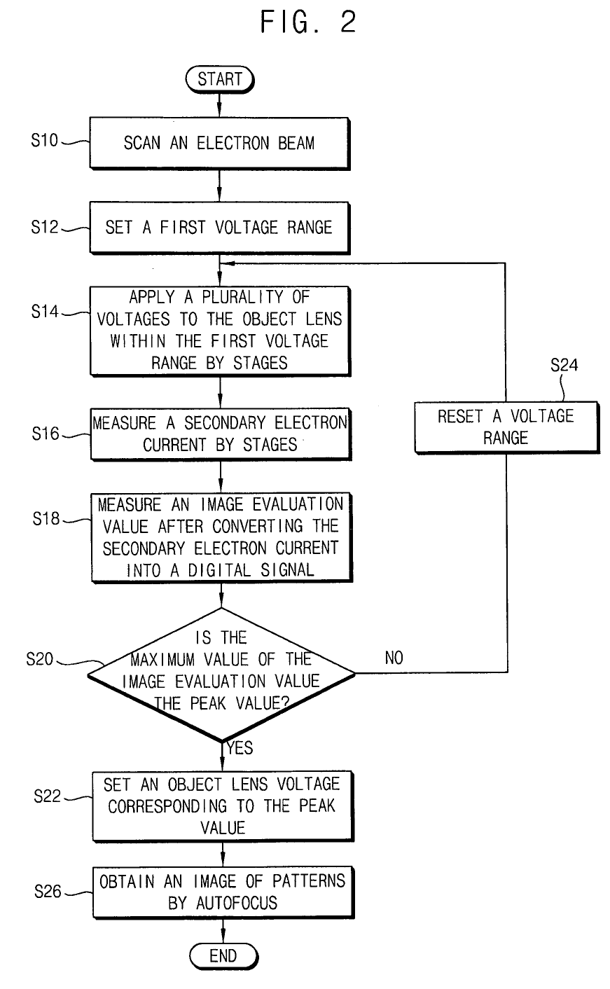

FIG. 2 is a flowchart illustrating an autofocus method in the SEM in FIG. 1 in accordance with some example embodiments of the present invention.

Hereinafter, a semiconductor substrate which may include electronic circuits formed therein is described as the subject 30; however, other objects may also serve as the subject 30.

Referring to FIGS. 1 and 2, in step S10, an electron beam generated by the electron gun 12 is scanned onto the substrate 30. The electron beam is condensed onto a specific portion of the substrate 30 after the electron beam passes by the lens assembly 22. The electron beam initially scanned onto the substrate 30 may not have an optimum focal distance between the substrate and the electron beam.

In step S12, a first voltage range for applying a voltage to the object lens 18 is set.

In the present embodiment, the focus is controlled by the voltage applied to the object lens 18; however, the focus may be controlled by a current applied to the object lens 18. In this case, a first current range for applying the current to the object lens 18 is set. Further, voltages in all following steps may be replaced by currents. That is, the focus may be controlled by performing substantially the same steps as the following steps except that the currents instead of the voltages are applied to the object lens 18. The voltages or the currents may serve as the setting conditions of the object lens 18.

In step S14, a plurality of voltages within the first voltage range is applied to the object lens 18 in stages. That is, the voltage applied to the object lens 18 is changed within the first voltage range. For example, the first voltage range may be divided into about 5 to about 20 portions, and voltages in the portions of the first voltage range may be applied to the object lens 18 in stages.

In step S16, an amount of secondary electrons emitted from the substrate (hereinafter referred to as a secondary electron current) is measured at every stage when the plurality of voltages within the first voltage range is applied to the object lens 18 in stages.

In step S18, the secondary electron current is converted into a digital signal, and an image evaluation value is measured.

In step S20, a first maximum value of the measured image evaluation value throughout the stages is measured, and whether the first maximum value of the image evaluation value is a peak value is checked. The peak value corresponds to an extreme value of the image evaluation value.

That is, when the first maximum value of the image evaluation value is the peak value, the image evaluation value has an extreme value within the first voltage range in a graph including an x-axis indicating the first voltage range and a y-axis indicating the image evaluation value. When the first maximum value of the image evaluation value is not the peak value, the image evaluation value does not have an extreme value within the first voltage range in the graph including the x-axis indicating the first voltage range and the y-axis indicating the image evaluation value. In this case, the first maximum value of the image evaluation value may be obtained at the highest value or the lowest value within the first voltage range.

In step S22, when the first maximum value of the image evaluation value is the peak value, a voltage of the object lens 18 corresponding to the peak value is measured, and the measured voltage is applied to the object lens 18. Thus, the focus between the substrate and the electron beam may be accurately controlled.

As described above, when the first maximum value of the image evaluation value is the peak value, the focus may be controlled. However, when the first maximum value of the image evaluation value within the first voltage range is not the peak value, the focus may not be accurately controlled by applying the voltage corresponding to the first maximum value to the object lens 18. In this case, additional steps for controlling the focus are needed.

In step S24, when the first maximum value of the image evaluation value is not the peak value, another voltage range that is adjacent to the first voltage range and includes the voltage corresponding to the first maximum value is set as a second voltage range. The term “adjacent to” used herein may include overlapping ranges.

The second voltage range may be set to have a value range higher than the first voltage range, or may be set to have a value range lower than the first voltage range. Preferably, the second voltage range is set to include a voltage at which the image evaluation value is higher than that of the first voltage range.

Particularly, when the image evaluation value has the first maximum value at the highest voltage within the first voltage range, the second voltage range may be set to include voltages equal to or higher than the above highest voltage within the first voltage range. When the image evaluation value has the first maximum value at the lowest voltage within the first voltage range, the second voltage range may be set to include voltages equal to or lower than the above lowest voltage within the first voltage range.

When a portion of the second voltage range that does not belong to the first voltage range is below about 30% based on the total second voltage range, too many voltage ranges are needed to measure the peak value of the image evaluation value. Additionally, when the portion of the second voltage range that does not belong to the first voltage range is above about 90% based on the total second voltage range, measuring the peak value of the image evaluation value may not be precise. Thus, the portion of the second voltage range that does not belong to the first voltage range may be in a range of about 30% to about 90% based on the total second voltage range.

For example, when the first voltage range is from 45,000 to 47,000 LSB, and the image evaluation value has a first maximum value at the voltage of 47,000 LSB, then the second voltage range may be set to be from 46,000 to 48,000 LSB.

In step S14, a plurality of voltages within the second voltage range is applied to the object lens 18 in stages.

In step S16, a secondary electron current is measured at every stage when the plurality of voltages within the second voltage range is applied to the object lens 18 in stages.

In step S18, the secondary electron current is converted into a digital signal, and an image evaluation value is measured.

In step S20, a second maximum value of the measured image evaluation value throughout the stages is measured, and whether the second maximum value of the image evaluation value is a peak value is checked.

When the second maximum value of the image evaluation value within the second voltage range is not the peak value, another voltage range is set and a voltage of the object lens 18 corresponding to the peak value is sought as follows.

A voltage range that is adjacent to an (n−1)th voltage range and includes the voltage corresponding to an (n−1)th maximum value of the image evaluation value within the (n−1)th voltage range is set as an n-th voltage range (n is an integer 3 or more). A plurality of voltages within the n-th voltage range is applied to the object lens 18 in stages. A secondary electron current is measured at every stage when the plurality of voltages within the n-th voltage range is applied to the object lens 18 in stages. The secondary electron current is converted into a digital signal, and an image evaluation value is measured. An n-th maximum value of the measured image evaluation value throughout the stages is measured, and whether the n-th maximum value of the image evaluation value is the peak value is checked. The above steps are repeated until the n-th maximum value of the image evaluation value becomes the peak value.

In step S22, the voltage corresponding to the peak value is applied to the object lens 18, and thus the focus between the substrate and the electron beam may be accurately controlled.

In step S26, after accurately controlling the focus, an electron beam passes through the condensing member and is scanned onto the substrate, so that images of the substrate may be obtained.

Additionally, a process for inspecting patterns formed on the substrate may be performed using the obtained images. The images may be clear so that the inspection process may be accurately performed.

Hereinafter, an Experiment of the autofocus method according to the present invention is described.

Experiment

A substrate on which linear patterns are formed is prepared.

The substrate is provided into the vacuum chamber of the SEM in accordance with some example embodiments of the present invention, and an electron beam generated by the electron gun is scanned onto the substrate. The electron beam is condensed onto a specific portion of the substrate after passing through the lens assembly.

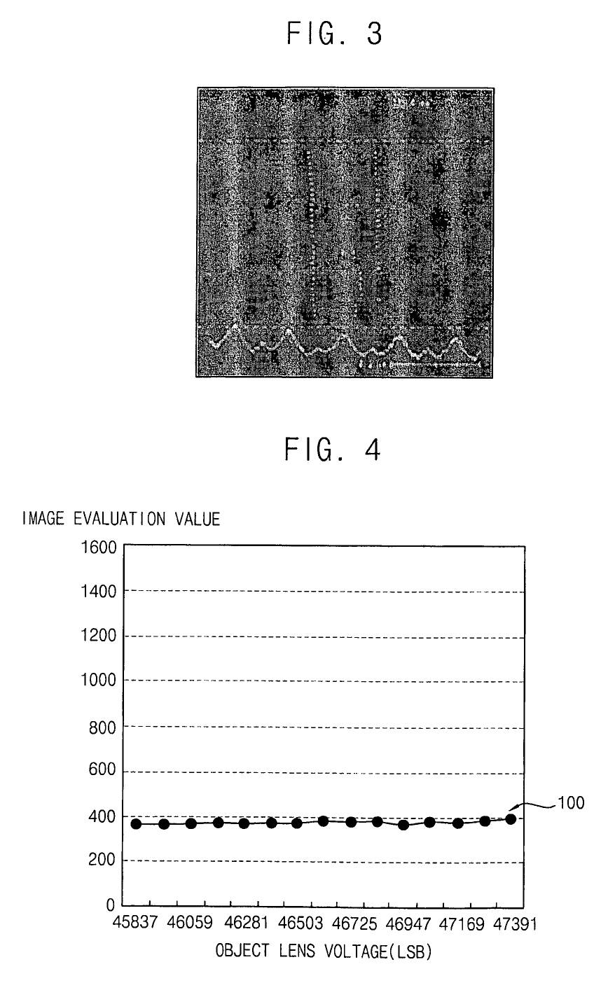

FIG. 3 is a SEM image of the patterns on the substrate before controlling the focus.

Referring to FIG. 3, the electron beam initially scanned onto the substrate did not have an optimum focal distance between the substrate and the electron beam.

In an actual method for controlling the focus, obtaining images of the patterns is not needed when the optimum focal distance is not obtained. However, images of the patterns before controlling the focus were obtained so as to be compared with images of the patterns after controlling the focus.

A plurality of voltages within a first voltage range was applied to an object lens in stages.

An image evaluation value was measured at every stage when the plurality of voltages within the first voltage range was applied to the object lens in stages.

FIG. 4 is a graph showing the image evaluation value measured in stages within the first voltage range.

In FIG. 4, the x-axis indicates a voltage resolution by the least significant bit (LSB) converted from the voltage applied to the object lens. Particularly, the x-axis includes a voltage resolution of about 45,837 to about 47,391 LSB, and the first voltage range was divided into 15 portions so that 15 voltages were applied to the object lens in stages. Thus, voltages applied to the object lens had a difference of about 111 LSB therebetween.

The image evaluation value was calculated by a calculator included in the SEM. Particularly, the image evaluation value was measured by detecting a secondary electron beam from the substrate at each voltage when the plurality of voltages is applied to the object in stages, and converting the secondary electron beam into a digital signal.

Referring to FIG. 4, a first maximum value 100 of the image evaluation value measured within the first voltage range was not the peak value. The first maximum value 100 was measured at a voltage of 47,391 LSB, which is the highest value of the voltages applied to the object lens within the first voltage range.

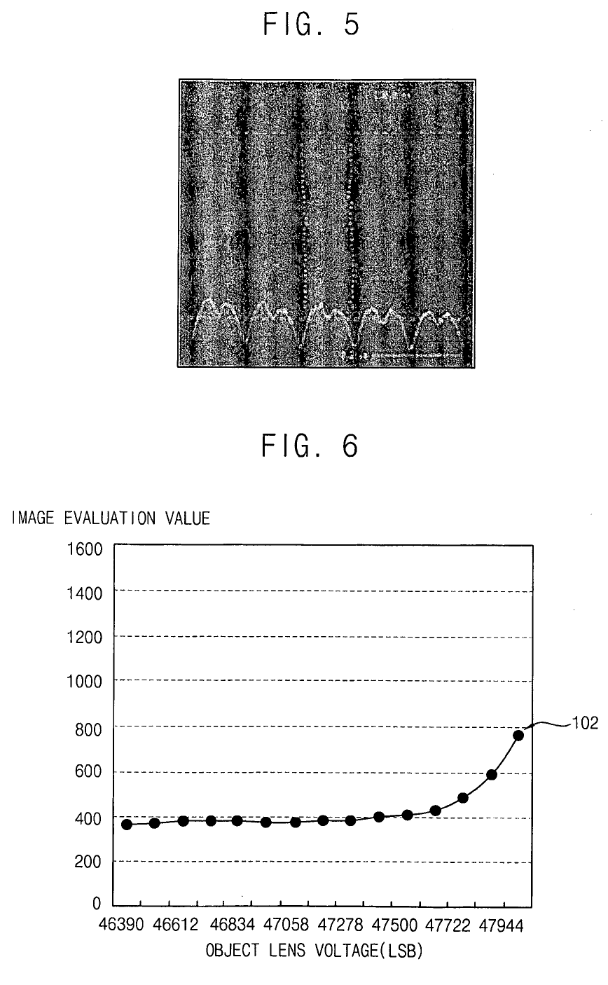

FIG. 5 is a SEM image of the patterns on the substrate when the highest value within the first voltage range was applied to the object lens.

Referring to FIG. 5, the image of the patterns was not clear even though the focus was controlled using the voltage corresponding to the first maximum value 100 of the image evaluation value, because the first maximum value 100 was not the peak value.

As mentioned above, since the first maximum value 100 was not the peak value, another voltage range adjacent to the first voltage range and including the voltage corresponding to the first maximum value 100 of the image evaluation value was set as a second voltage range.

Particularly, the second voltage range includes a voltage resolution of about 46,390 to about 47,944 LSB, and the second voltage range was divided into 15 portions so that 15 voltages were applied to the object lens in stages. Thus, voltages applied to the object lens had a difference of about 111 LSB therebetween.

A plurality of voltages within a second voltage range was applied to an object lens in stages. An image evaluation value was measured by detecting a secondary electron beam from the substrate at each voltage when the plurality of voltages within the second voltage range is applied to the object in stages, and converting the secondary electron beam into a digital signal.

FIG. 6 is a graph showing the image evaluation value measured in stages within the second voltage range.

Referring to FIG. 6, a second maximum value 102 of the image evaluation value measured within the second voltage range was not the peak value. The second maximum value 102 was measured at a voltage of 47,944 LSB, which is the highest value of the voltages applied to the object lens within the second voltage range.

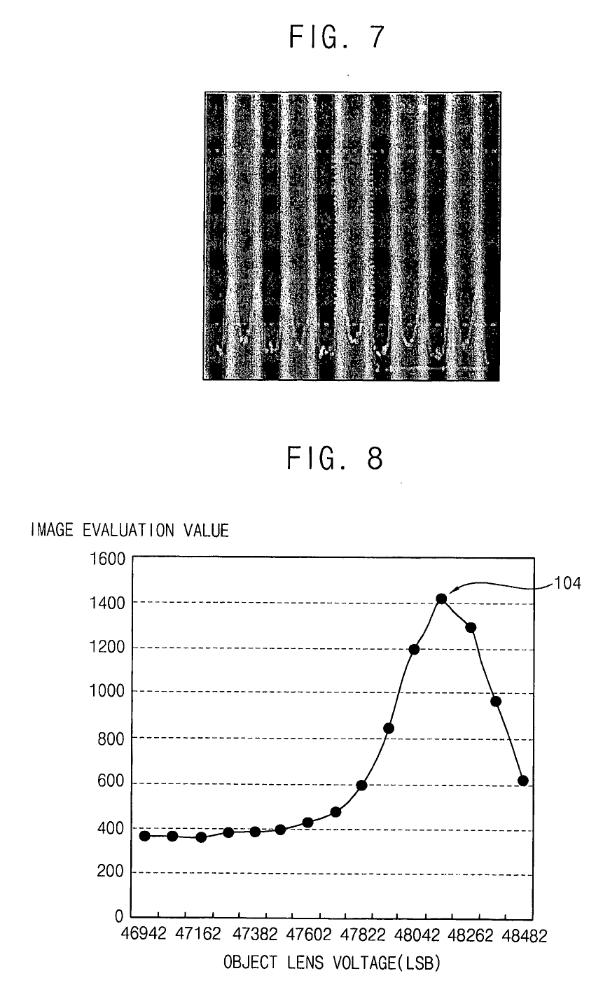

FIG. 7 is a SEM image of the patterns on the substrate when the highest value within the second voltage range was applied to the object lens.

Referring to FIG. 7, the image of the patterns was not clear even though the focus was controlled using the voltage corresponding to the second maximum value 102 of the image evaluation value, because the second maximum value 102 was not the peak value.

As mentioned above, since the second maximum value 102 was not the peak value, still another voltage range adjacent to the second voltage range and including the voltage corresponding to the second maximum value 102 of the image evaluation value was set as a third voltage range.

Particularly, the third voltage range includes a voltage resolution of about 46,942 to about 48,482 LSB, and the third voltage range was divided into 15 portions so that 15 voltages were applied to the object lens in stages. Thus, voltages applied to the object lens had a difference of about 111 LSB therebetween.

A plurality of voltages within a third voltage range was applied to an object lens in stages. An image evaluation value was measured by detecting a secondary electron beam from the substrate at each voltage when the plurality of voltages within the third voltage range is applied to the object in stages, and converting the secondary electron beam into a digital signal.

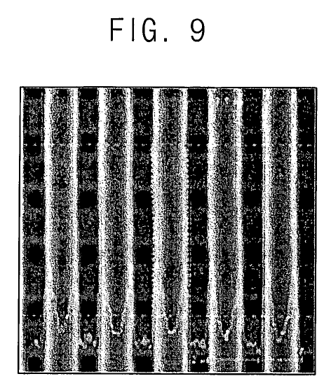

FIG. 8 is a graph showing the image evaluation value measured in stages within the third voltage range.

Referring to FIG. 8, a third maximum value 104 of the image evaluation value measured within the third voltage range was the peak value. The third maximum value 104, i.e., the peak value was measured at a voltage of 48,153 LSB, which is a 12^{th} voltage within the third voltage range.

FIG. 9 is a SEM image of the patterns on the substrate when the 12^{th} value within the third voltage range was applied to the object lens.

Referring to FIG. 9, the image of the patterns was clear when the focus was controlled using the voltage corresponding to the third maximum value 104 of the image evaluation value, because the third maximum value 102 was the peak value.

As described above, clear images of patterns may be obtained by controlling the focus and widths of the patterns may be accurately measured.

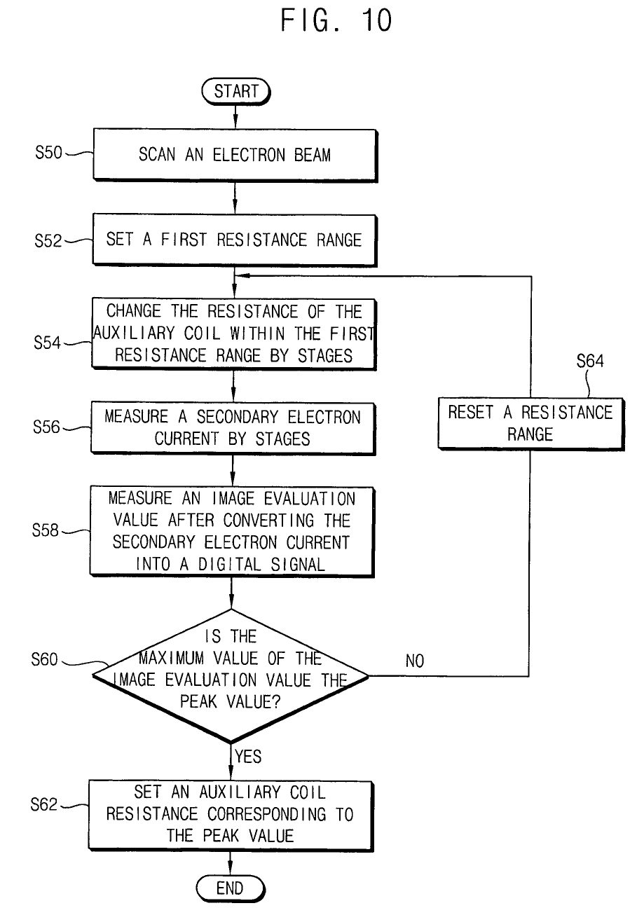

FIG. 10 is a flowchart illustrating an autofocus method in the SEM in FIG. 1 in accordance with other example embodiments of the present invention. In the present embodiment, a resistance of the auxiliary coil 20 may serve as a setting condition.

Hereinafter, a semiconductor substrate in which electronic circuits may be formed is used as the subject 30; however, other objects may also serve as the subject 30.

Referring to FIGS. 1 and 10, in step S50, an electron beam generated by the electron gun 12 is scanned onto the substrate 30.

In step S52, a first resistance range within which a resistance of the auxiliary coil 20 may be changed is set.

In step S54, the resistance of the auxiliary coil 20 is changed within the first resistance range in stages in order to change the focus of the electron beam. That is, a plurality of resistances within the first resistance range is applied to the auxiliary coil 20 in stages. For example, the first resistance range may be divided into about 5 to about 20 portions, and resistances in the portions of the first resistance range may be applied to the auxiliary coil 20 in stages.

In step S56, a secondary electron current is measured at every stage when the plurality of resistances within the first resistance range is applied to the auxiliary coil 20 in stages.

In step S58, the secondary electron current is converted into a digital signal, and an image evaluation value is measured.

In step S60, a first maximum value of the measured image evaluation value throughout the stages is measured, and whether the first maximum value of the image evaluation value is a peak value is checked.

In step S62, when the first maximum value of the image evaluation value is the peak value, a resistance of the auxiliary coil 20 corresponding to the peak value is measured, and the measured resistance is applied to the auxiliary coil 20. Thus, the focus between the substrate and the electron beam may be accurately controlled.

However, when the first maximum value of the image evaluation value is not the peak value, the focus may not be accurately controlled by applying the resistance corresponding to the first maximum value to the auxiliary coil 20. In this case, additional steps for controlling the focus are needed.

In step S64, when the first maximum value of the image evaluation value is not the peak value, another resistance range that is adjacent to the first resistance range and includes the resistance corresponding to the first maximum value is set as a second resistance range.

The second resistance range may be set to have a value range higher than the first resistance range, or may be set to have a value range lower than the first resistance range. Preferably, the second resistance range is set to include a resistance at which the image evaluation value is higher than that of the first resistance range.

In step S54, the resistance of the auxiliary coil 20 is changed within the second resistance range in stages. In step S56, a secondary electron current is measured at every stage when the plurality of resistances within the second resistance range is applied to the auxiliary coil 20 in stages. In step S58, the secondary electron current is converted into a digital signal, and an image evaluation value is measured.

In step S60, a second maximum value of the measured image evaluation value throughout the stages is measured, and whether the second maximum value of the image evaluation value is a peak value is checked.

When the second maximum value of the image evaluation value is not the peak value, another resistance range is set and a resistance of the auxiliary coil 20 corresponding to the peak value is sought as follows.

A resistance range that is adjacent to an (n−1)th resistance range and includes the resistance corresponding to an (n−1)th maximum value of the image evaluation value within the (n−1)th resistance range is set as an n-th resistance range (n is an integer over 3). A plurality of resistances within the n-th resistance range is applied to the auxiliary coil 20 in stages. A secondary electron current is measured at every stage when the plurality of resistances within the n-th resistance range is applied to the auxiliary coil 20 in stages. The secondary electron current is converted into a digital signal, and an image evaluation value is measured. An n-th maximum value of the measured image evaluation value throughout the stages is measured, and whether the n-th maximum value of the image evaluation value is a peak value or not is checked. The above steps are repeated until the n-th maximum value of the image evaluation value becomes the peak value.

In step S62, the resistance corresponding to the peak value is applied to the auxiliary coil 20, and thus the focus between the substrate and the electron beam may be accurately controlled.

In the previous example embodiments, an object lens or an auxiliary coil is used for controlling the focus. However, other condensing members, such as a condensing lens, may be also used for controlling the focus.

As described above, some steps for controlling the focus may be added or omitted according to the initial focal state.

For example, when the peak value is detected at a voltage within the first voltage range, the time for scanning electrons onto the subject may be reduced. Thus, the subject may be prevented from being burned or charged unnecessarily, and thus may be prevented from being deformed.

Additionally, when the peak value is not detected at a voltage within the first voltage range, steps for controlling the focus may be further performed, so that an optimum focal point may be detected. Thus, the inspection process may be accurately performed.

According to some example embodiments of the present invention, damage to a subject due to excessive exposure to an electron beam may be reduced and an optimum focal point between the subject and the electron beam may be obtained. Thus, clear images of the subject may be obtained using a SEM, and defects of the subject or the size of patterns formed on the subject may be accurately detected.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. An autofocus method comprising:
scanning an electron beam onto a subject through a condensing member;
changing a setting condition of the condensing member within a first range in stages;
measuring an image evaluation value using a first secondary electron current from the subject according to the setting condition within the first range;
setting a second range when a first maximum value of the image evaluation value is not a peak value, the second range being adjacent to the first range and including the setting condition corresponding to the first maximum value;
changing the setting condition within the second range in stages;
measuring an image evaluation value using a second secondary electron current from the subject according to the setting condition within the second range; and
setting the condensing member with the setting condition corresponding to a second maximum value of the image evaluation value when the second maximum value is the peak value.

2. The method of claim 1, wherein the condensing member includes at least one of an object lens and a coil.

3. The method of claim 2, wherein the setting condition is a voltage applied to the object lens when the condensing member includes the object lens.

4. The method of claim 2, wherein the setting condition is a resistance of the coil when the condensing member includes the coil.

5. The method of claim 1, further comprising:
obtaining an image of the subject by scanning an electron beam onto the subject through the condensing member that has been set by the setting condition corresponding to the peak value of the image evaluation value; and
inspecting patterns on the subject using the obtained image.

6. The method of claim 1, when the second maximum value is not the peak value, further comprising:
i) setting an n-th range being adjacent to an (n−1)th range and including the setting condition corresponding to an (n−1)th maximum value of the image evaluation value within the (n−1)th range, wherein n is an integer over 3;
ii) changing the setting condition within the n-th range in stages;
iii) measuring an image evaluation value using an n-th secondary electron current from the subject according to the setting condition within the n-th range;
iv) checking whether an n-th maximum value of the image evaluation value within the n-th range is the peak value; and
v) repeatedly performing steps i) to iv), when the n-th maximum value is not the peak value.

7. The method of claim 1, wherein the second range is set to include a setting condition at which the image evaluation value is higher than that of the first range.

8. An autofocus method comprising:
scanning an electron beam onto a subject through an object lens;
applying a first plurality of voltages to within a first voltage range the object lens in stages;
measuring an image evaluation value using a first secondary electron current from the subject according to the voltage applied to the object lens within the first range;
setting a second voltage range when a first maximum value of the image evaluation value within the first voltage range is not a peak value, the second voltage range being adjacent to the first voltage range and including the voltage corresponding to the first maximum value;
applying a second plurality of voltages to within the second voltage range the object lens in stages;
measuring an image evaluation value using a second secondary electron current from the subject according to the voltage applied to the object lens within the second voltage range;
obtaining a voltage applied to the object lens when a second maximum value of the image evaluation value within the second voltage range is the peak value; and
applying the obtained voltage corresponding to the peak value to the object lens.

9. The method of claim 8, wherein a portion of the second voltage range that does not belong to the first voltage range is in a range of about 30% to about 90% based on the total second voltage range.

10. The method of claim 8, wherein the second voltage range is set to include a voltage at which the image evaluation value is higher than that of the first voltage range.

11. The method of claim 8, when the second maximum value is not the peak value, further comprising:
i) setting an n-th voltage range being adjacent to an (n−1)th range and including the voltage corresponding to an (n−1)th maximum value of the image evaluation value within the (n−1)th voltage range, wherein n is an integer over 3;
ii) applying a plurality of voltages to the object lens within the n-th range in stages;
iii) measuring an image evaluation value using an n-th secondary electron current from the subject according to the voltage within the n-th range;
iv) checking whether an n-th maximum value of the image evaluation value within the n-th voltage range is the peak value; and
v) repeatedly performing steps i) to iv), when the n-th maximum value is not the peak value.

12. The method of claim 8, further comprising:
obtaining an image of the subject by scanning an electron beam onto the subject through the object lens that has been set by the voltage corresponding to the peak value; and
inspecting patterns on the subject using the obtained image.
